(19) United States
(12) Patent Application Publication
(10) Pub. No.: US 2008/0255921 A1
(43) Pub. Date: Oct. 16, 2008

(54) PERCENTAGE BASED ONLINE ADVERTISING

(75) Inventors: Gary W. Flake, Bellevue, WA (US); Brett D. Brewer, Sammamish, WA (US); Dennis M. DeCoste, Mercer Island, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/734,134

(22) Filed: Apr. 11, 2007

(51) Int. Cl. G06Q 30/00

(52) U.S. Cl. 705/10; 705/14; 705/400

(57) ABSTRACT

The subject disclosure pertains to systems and methods that facilitate percentage based online advertising. Systems and methods described herein enable an advertiser to elect a share or percentage of a particular market instead of, or in addition to, submitting bids to auction-based advertising systems. Markets can be defined based upon impressions, clicks, actions or any other suitable attributes. For example, additional attributes can include user demographics (e.g., age, gender, geographic location, education, and interests), specified time periods (e.g., weekdays and business hours) and the like. Advertisers can also specify constraints that limit market share requests. Such constraints can include a maximum total cost, a specific time period or periods, a maximum cost within a limited time period and the like.

### BACKGROUND

The Internet provides unprecedented access to an ever-increasing number of potential online customers ranging from businesses to individuals. Money expended for online advertising in the United States alone is in the billions of dollars per year, and continues to increase with no end in sight. Accordingly, businesses recognize the value in online advertising and continue to seek better ways to reach these potential customers with information about their products and services.

Online advertising can be a particularly valuable tool, since advertisements can be targeted to Internet users that have indicated an interest in specific subjects or products. User activities and access information can now be tracked in the form of cookies, for example, thereby providing information about the buying habits, goals, intentions, and needs of large numbers of users. It then becomes possible to target groups of users, for example, based on this information. Accordingly, the quality and value received from online advertising can translate into potentially huge returns to the advertising dollars of businesses.

As the popularity of online advertising has increased, the sophistication of the online advertising market has also grown. Advertisements can be included on web pages and displayed along with results generated by search engines. Retailers can bid or pay for certain keywords or phrases related to their products to attempt to target Internet users most likely to purchase their products.

Costs or fees for online advertisements can be based on any number of attributes. One popular system utilizes cost per impression (CPI) to determine advertising fees. In a CPI system, websites or search engines are paid for each advertisement displayed and presumably seen by a potential customer. The number of times a particular advertisement is shown can be tracked and used to calculate the advertising fees.

Other popular fee systems include performance-based systems that require some act or performance by the targeted Internet user. For instance, in a pay per click (PPC) system, website operators receive a predetermined fee from the retailer or advertiser every time a website user selects or clicks on an advertisement to view additional information or access a retailer's website. In a cost per action (CPA) system, advertisers only pay for an advertisement when a particular action occurs, such as purchase of a product, completion of a form and the like.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns sale of market share or percentage for an online advertising system. Typically, search engines sell online advertising through an auction process where advertisers bid for specific keywords and phrases. Advertisers submit bids stating their maximum willingness to pay for a click or impression for a specific term or keyword. Advertisers are generally billed based upon number of impressions or number of clicks for their advertisement.

The systems and methods described herein enable an advertiser to elect a desired share or percentage of a particular market, rather than submitting individual bids. Markets can be defined based upon impressions, clicks, actions or any other suitable attributes. Additional attributes can include user demographics (e.g., age, geographical location, gender and interests), specific time frames (e.g., weekends and business hours), time zones and the like. Advertisers can define constraints that limit market share requests. Such constraints can include a maximum total cost, a specific time period or periods, a maximum cost within a limited time period and the like.

Requests for market shares allow advertisers to express goals rather than requiring advertisers to estimate bids necessary to achieve such goals. Division of markets based upon such requests can be accomplished in various ways. Data collected based upon previous market transactions can used to compute bids for an auction-based system. Alternatively, advertisements provided at each advertising opportunity can be randomly determined, where such determination is biased based upon the elected market shares. Computations of fees and/or bids can be updated based upon new transaction information to adjust for changes in the market.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that enables advertisers to request market shares in an online advertising market in accordance with an aspect of the subject matter disclosed herein.

FIG. 2 illustrates an exemplary division of impressions or occurrences of an advertisement in accordance with an aspect of the subject matter disclosed herein.

FIG. 3 is a block diagram of a system that enables percentage based online advertising in accordance with an aspect of the subject matter disclosed herein

FIG. 4 illustrates percentage based online advertising as a process control problem in accordance with an aspect of the subject matter disclosed herein.

FIG. 5 is a block diagram of a fee component in accordance with an aspect of the subject matter disclosed herein.

FIG. 6 illustrates an exemplary market distribution in accordance with an aspect of the subject matter disclosed herein.

FIG. 7 is a block diagram of another aspect of a fee component in accordance with an aspect of the subject matter disclosed herein.

FIG. 8 illustrates an exemplary distribution of market prices in accordance with an aspect of the subject matter disclosed herein.

FIG. 9 illustrates an exemplary methodology for defining market share and facilitating market percentage based online advertising in accordance with an aspect of the subject matter disclosed herein.

FIG. 10 illustrates an exemplary methodology for online advertising based upon market share percentage in accordance with an aspect of the subject matter disclosed herein.

FIG. 11 illustrates an exemplary methodology for determining appropriate advertisement(s) for an advertising opportunity in accordance with an aspect of the subject matter disclosed herein.

FIG. 12 illustrates another exemplary methodology for determining appropriate advertisement(s) for an advertising opportunity in accordance with an aspect of the subject matter disclosed herein.

FIG. 13 illustrates a further exemplary methodology for determining appropriate advertisement(s) for an advertising opportunity in accordance with an aspect of the subject matter disclosed herein.

FIG. 14 is a schematic block diagram illustrating a suitable operating environment.

FIG. 15 is a schematic block diagram of a sample-computing environment

### DETAILED DESCRIPTION

The various aspects of the subject matter disclosed herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

The advertising market for terms or keywords is complex. Typically, search engines sell online advertising through an auction process where advertisers bid for specific keywords and phrases. Web page results generally include both links most relevant to the query and sponsored links (e.g., paid advertisements). Presentation of results on the web page allows users to distinguish advertisements from actual search results. The advertisements presented are dependent upon the search query. If a user selects a sponsored link, he or she is sent to the advertiser's web page. The user click can constitute a referral to the advertiser from the search engine and the advertiser may pay the search engine a fee for referring users (e.g., “pay-per-click” pricing). As used herein, the term advertisement can include a web page link, text, graphic, audio, video or any other media.

The number of advertisements delivered in response to a query is typically limited and desirability of positions on the page may vary. Generally, advertisers prefer that their sponsored links appear at the top, left portion of the page. Fees can vary based upon search terms and upon position of results on a page. Many search engines utilize an auction system, such as a Generalized Second Price (GSP) auction to allocate positions to advertisers.

In a GSP auction, advertisers submit bids stating their maximum willingness to pay for a click for a specific term or keyword. When a user enters a keyword, he receives search results along with sponsored links, the latter shown in decreasing order based upon received bids. In particular, the advertisement with the highest bid may be displayed at the top of the page; the advertisement with the next highest bid may be displayed at the position second from the top and so forth. If a user selects a sponsored link, the advertiser is charged the amount of the next lower bid. For example, if the top-most sponsored link were selected, the advertiser would be charged the amount of the bid for the sponsored link in the second position. If only one sponsored link were displayed per page, GSP would be equivalent to a standard second price, or Vickrey-Clarke-Groves (VCG) auction.

Many popular search engines utilize a variation of the GSP auction. Frequently, advertisers' bid price is combined with expected click through rate (CTR) to compute an expected monetization score. In the variation, auctions are based upon the expected monetization score instead of bids and sponsored links are presented in decreasing order of expected monetization scores. Advertisers can bid for a single keyword, a keyword and additional search terms or a phrase. The bidding process can be blind or open, such that bidder's bid price and identity may or may not be disclosed to other bidders.

Various auction systems require advertisers to determine an appropriate bid price to ensure sufficient marketing of their products. Typically, advertisers will have an imperfect knowledge of the online market from which to determine their bid price. Additionally, advertisers may not have the ability or desire to monitor the market and adjust their bid price in an efficient manner. However, advertisers and marketers may be interested in ensuring that a specific share or percentage of the public or market of their products. In particular, the goal of advertising campaigns that focus upon word of mouth may be focused on ensuring that a percentage of the market views or selects the advertisement.

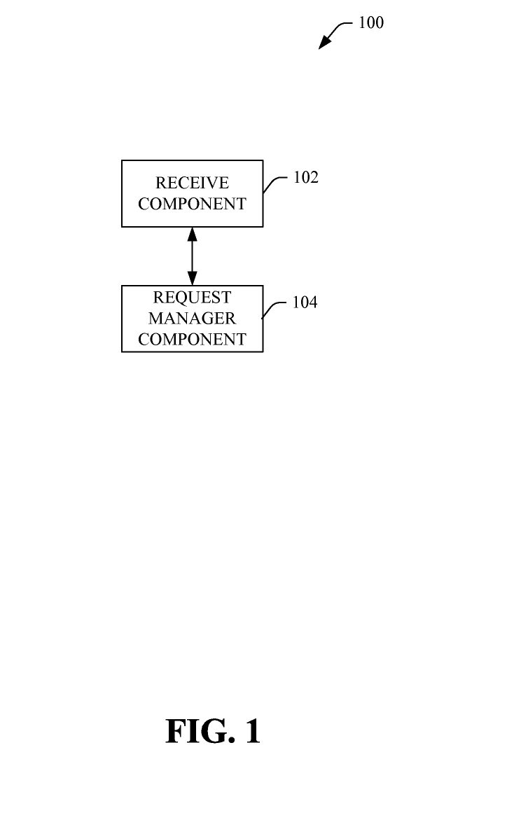

Turning now to the figures, FIG. 1 illustrates a system 100 that enables advertisers to request a share or percentage of a specified market in accordance with an aspect of the subject matter disclosed herein. Instead of bidding for impressions or clicks, advertisers can input a target percentage for a particular market. A market can be described or defined based upon a set of attributes. For example, the market can consist of the total number of impressions or views of a web page. Alternatively, the market can include only clicks or actual selections of an advertisement, rather than impressions of the advertisement. Furthermore, advertisers can specify attributes to eliminate repeated impressions or views by a single potential customer. Additional attributes can include, but are not limited to, user demographics (e.g., gender, age, geographic location and interests), time periods and location or position of the advertisement on a web page or within a list of results.

The system 100 can include a receive component 102 that can receive or obtain market share requests that specify a particular percentage or range of acceptable percentages within a particular market for an advertisement. The request can contain one or more attributes describing the relevant market or a reference to a predetermined market. The actual advertisement can be included within the market share request or can be provided separately by advertisers. The market share request can also include one or more constraints elected by the advertiser. Constraints define limitations on the request for a market share. In particular, constraints can include maximum total cost for the market share, a maximum cost per a specified time period, maximum amount per event or occurrence (e.g., cost per click, action or impression) and the like. In an example request, an advertiser can request that the advertiser's advertisement be included on a web page such that 20% of users that view a particular page see the advertisement. The request can include constraints that limit costs to $1,000 in total, $100 for each week and no more than $2 for any particular display of the advertisement.

A request manager component 104 can influence the presentation or provision of advertisements based upon one or more requests received by the receive component 102. For each advertising opportunity, advertisements can be identified and selected for presentation based at least in part upon requested shares or market percentages, market attributes, specified constraints and any other information associated with a received market share request or requests. As used herein, an advertising opportunity refers to an opportunity to provide or display an advertisement. Advertising opportunities include, but are not limited to, display of a web page, including search result pages, provisioning of audio and video clips and the like. The request manager component 104 can influence provisioning of advertisements directly or indirectly, to control selection of advertisements. For example, request manager component can indirectly affect the advertising market by generating appropriate bids for use in an auction system, such that the generated bids secure the desired market percentage. Alternatively, the request manager component can select an advertisement or advertisements for an advertising opportunity to obtain desired market shares.

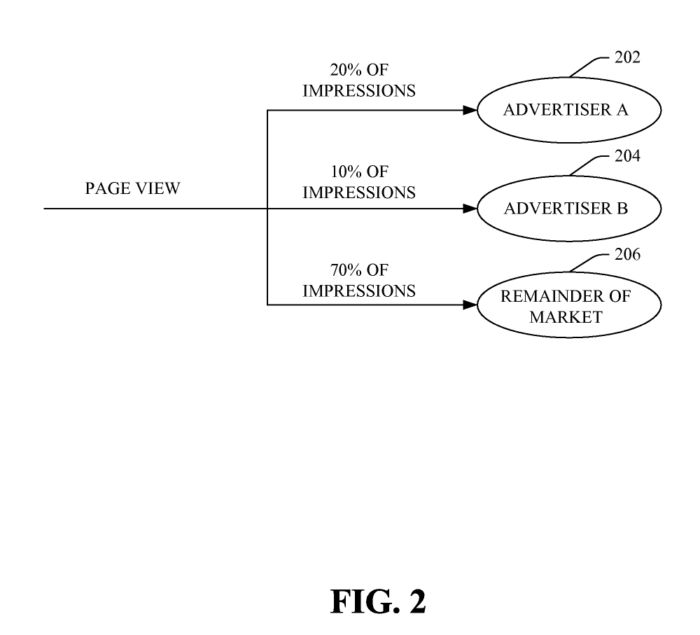

Referring now to FIG. 2, an exemplary division of impressions or occurrences of an advertisement is illustrated. Here, advertiser A 202 has elected a twenty percent market share, advertiser B 204 has elected ten percent of the market and the remaining 70% of the total market is available for any remaining advertisers 206. The fees for the percentages allocated to advertiser A 202, advertiser B 204 and the remainder of the market 206 can be computed in any suitable manner.

This simple division of occurrences can be effected by a determination at each advertising opportunity based upon relative requested market shares. In aspects, a biased random determination can be made. For instance, at an advertising opportunity, a random number can be generated and compared to a set of ranges or thresholds designed to distribute advertising opportunities in accordance with the elected market shares. Advertisements can be selected for display based upon the generated number. For example, for the division illustrated in FIG. 2, when an advertising opportunity arises, a random number can be generated and compared to thresholds selected such that there is a twenty percent chance that Advertiser A's ad will be shown, a ten percent chance that advertiser B's ad will be shown and a seventy percent chance that an advertisement from the remainder of the market will be shown. The seventy percent allocated to the remainder of the market can be divided using any suitable method or algorithm for distributing advertisements (e.g., auction systems).

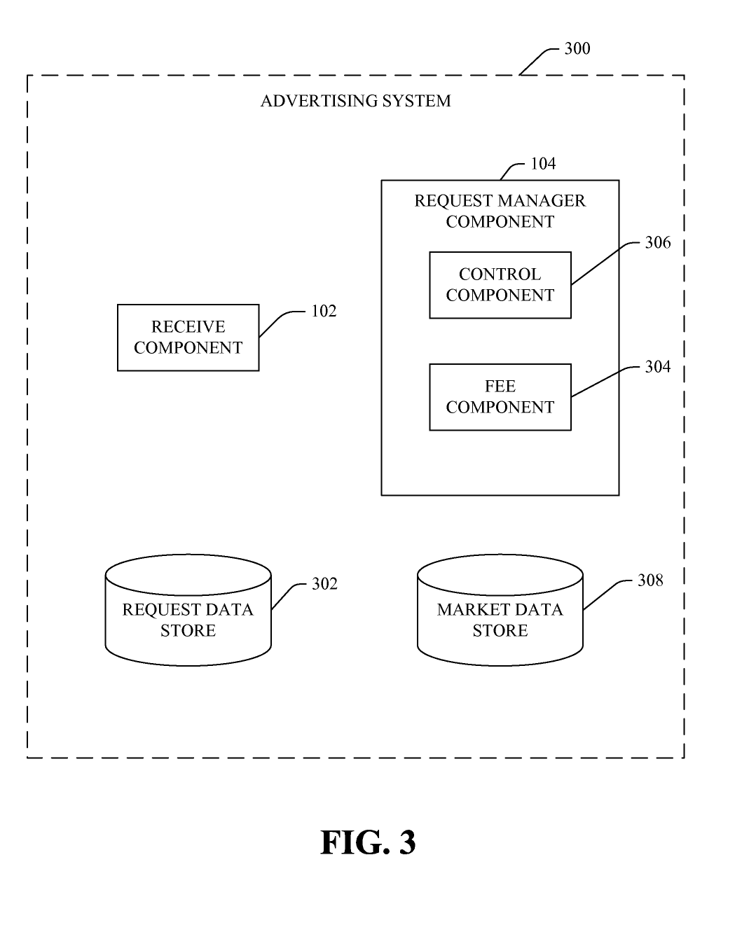

Turning now to FIG. 3, an exemplary system 300 that enables election of market percentages is illustrated. The system 300 includes a receive component 102 and a request manager component 104 similar to the components illustrated in FIG. 1. In addition, system 300 includes a request data store 302 that maintains a set of market share requests. As used herein, a data store includes any collection of data (e.g., a database, one of more files or a cache). Received market share requests can be stored when received. Requests can be edited, updated and/or deleted. For example, a market share can be requested for a specified period of time, such as the week leading up to an event (e.g., a sale or a holiday). After the event, the market share request would be inapplicable and can be deleted.

A user interface (not shown) can provide advertisers and/or advertising system managers with the ability to add, monitor, edit and delete market share requests. In particular, a graphic user interface (GUI) can be used to manage requests from multiple advertisers. Advertisers can utilize a web-based interface to monitor and adjust their market share requests to achieve their marketing goals.

When an advertising opportunity arises, relevant requests can be retrieved and used to determine provision of advertisements. Request manager component 104 can retrieve the relevant market share requests from the request data store 302 based upon the advertising opportunity and market attributes. For example, if it is known that the user is a woman and the advertiser A has requested 20% of the male user market, advertiser A's request is in applicable.

Request manager component 104 can include a fee component 304 that computes applicable fees or bid prices associated with advertisements. The fee component 302 can determine the appropriate fees to charge various advertisers based upon display of advertisements, user clicks and/or user actions. The fee component can utilize market information obtained from a market data store 308 to determine fees charged to advertisers. The market data store 308 can maintain market information including statistics regarding number of occurrences of particular events, bid prices, click through rates for various advertisements and/or advertisers, and any other information related to sale of online advertising.

While historical information can be useful in predicting future occurrences, markets are generally subject to change and online advertising markets can be particularly dynamic. The market data store 208 can be continually updated and fees can be recomputed periodically to reflect changes to various markets.

The request manager component 104 can include a control component 306 that effects provision or presentation of advertisements in accordance with market share requests. The control component 306 can effect or influence the requested market shares directly by controlling the advertisements displayed for advertising opportunities. Alternatively, the control component 306 can control market shares indirectly by generating bids based upon computations of the fee component 304 and submitting the bids to an auction based online marketing system (not shown). System 300 can directly control advertising opportunities. In other aspects, system 300 can be incorporated into, or used in conjunction with, an auction-based advertising system. In further aspects, system 300 may be independent, acting as an agent of advertisers and submitting bids to one or more auction systems.

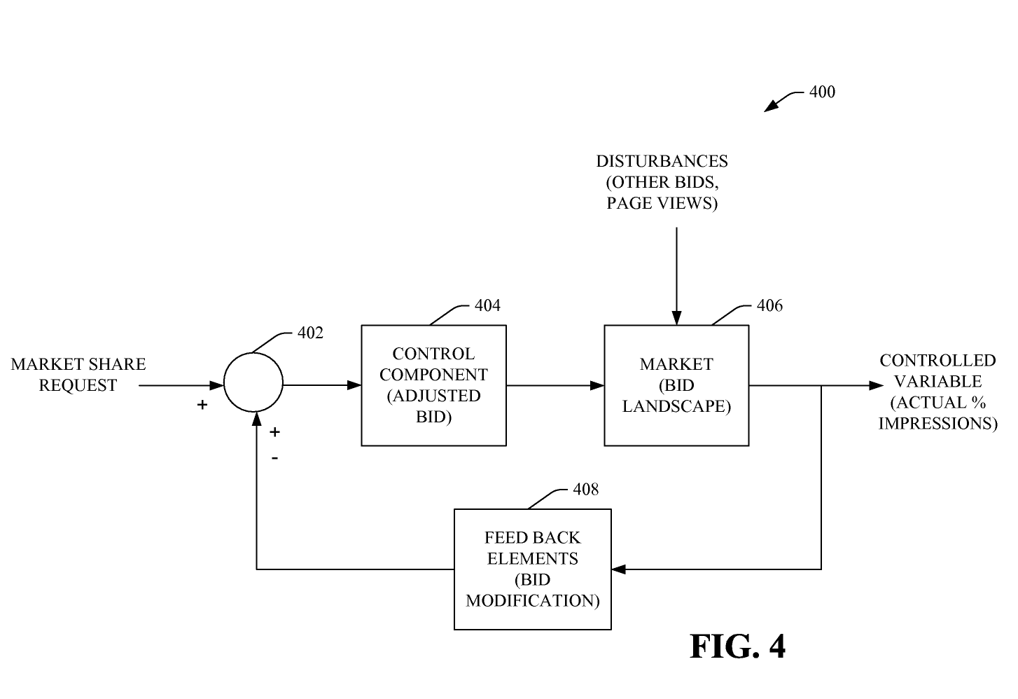

Referring now to FIG. 4, percentage based online advertising is depicted as a process control problem 400. Market share requests describe goals for a variable to be controlled. Here, the controlled variable is a percentage of a market for a particular advertiser. Goals or directions are applied at 402. Control element 404 acts to secure the goal specified in the request. For example, in an auction-based system an adjusted bid price is computed to ensure that the advertiser receives the desired market share. The market 406 or landscape of bids responds to the control element.

However, disturbances or forces outside of control of advertisement can affect the market 406. For example, if an advertiser requests a significant market share, other advertisers may increase their bid price in response to a decrease in the available portion of the particular market. Disturbances include any other changes outside of the control of the advertiser making the request. For example, changes in technology, competitors, seasons and the like. Consequently, advertisers may not obtain the exact percentage of the market requested.

Feedback element 408 provides information regarding the resulting controlled variable that can be used to evaluate and/or correct the control component to adjust the controlled variable. In particular, feedback information can be applied at 402 to adjust the control element 404 (e.g., bid price). For instance, if an advertiser has requested 30% of the market and due to increased bidding by a competitor has only be able to achieve 28% of the market, bid price may be increased to a level designed to secure 32% of the market. In this manner, an overall rate of 30% can be achieved. Once the advertising system has compensated for the initial deficit, the information from the feedback element 408 can be used reduce the bid price.

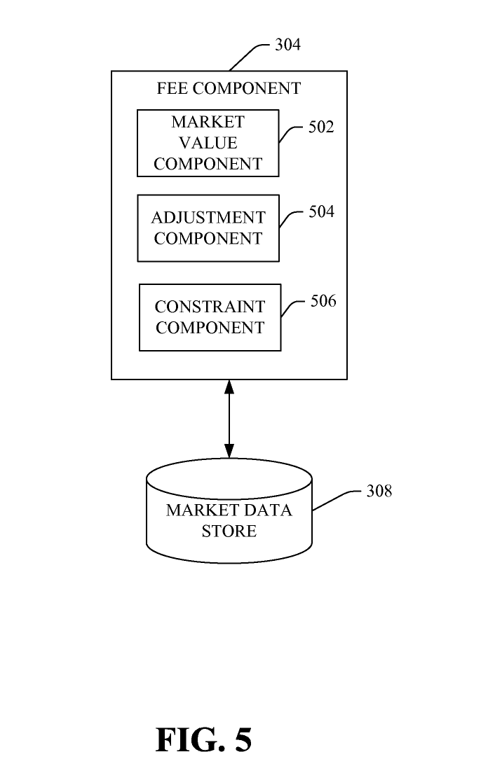

Referring now to FIG. 5, an aspect of the fee component 304 of FIG. 3 is illustrated. Fees or costs to the advertiser can be computed by predicting the probable value of market and computing the value of the requested share. The fee component 304 can include a market value component 502 that determines a probable value of a particular market based upon previously collected market information. Market information can be obtained from the market data store 308 and used to compute an estimated total value of the market for a specified period of time. The fee component 304 can determine individual fees or bid prices based upon the requested share of the total predicted value of the market. During advertising opportunities such as page views, a controller component (not shown) can use biased random determination to ensure that the advertisers that have elected a fixed percentage of the market obtain the desired share of impressions. Biased determination is analogous to flipping a biased coin to select from a set of advertisements. Any portion of the market not secured by an advertiser market share request can be distributed among the remaining advertisers using an auction-based system or any other suitable method.

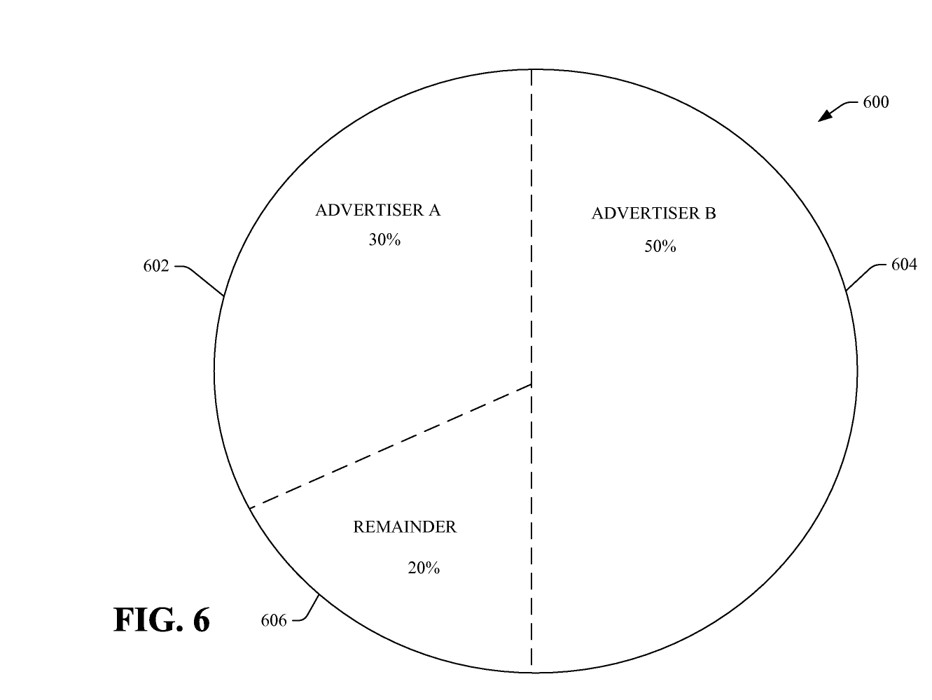

Referring briefly to FIG. 6, an exemplary market distribution 600 is illustrated. For a market consisting of potential customer impressions for one week, value of the market can be estimated based upon market information from a previous week. If a previous week consisted of 1,000 impressions at an average bid price of two dollars, then the total value of the market would be estimated at $2,000 per week. If advertiser A 602 has requested 30% of the market, the appropriate fee for advertiser A's share can be computed to be $600. Similarly, if advertiser B 604 has requested 50% of the market the appropriate fee for advertiser B's share can be computed to be $1,000. The remaining market share 606 of 20% can be distributed in any suitable manner.

Transaction information for the remaining market 606 can be used to update the fee computations for the market share requests. For example, the remaining advertisers may increase their bid prices to increase the number of impressions they receive. The market value component 502 can utilize the new market information to compute a new market value. For example, if remaining 20% of the market had 200 impressions with an average bid price of $3, then a total market of 1,000 impressions would have an increased estimated market value of $3,000 per week. Consequently, for 30% of the market the appropriate fee would be $900 and for 50% of the market the appropriate fee would be $1,500. Over time, fluctuations in the market would be automatically incorporated into the fees.

Referring once again to FIG. 5, fee component 304 can also include an adjustment component 504 that can compensate for market attributes and individual advertiser monetization factors. Monetization factors can include special rates or discounts for particular advertisers. The adjustment component 504 can modify fees based upon monetization factors for particular advertisers.

In addition, in pay per click or cost per action systems, monetization factors describe a ratio of monetizable events to impressions (e.g., number of actions per impressions and click through rate). In a pay per click system, an advertisement that has a high click through rate (CTR) is more likely to be selected and therefore more likely to result in an expense to the advertiser and a fee for the advertising system displaying the advertisement. In such markets, advertisers are effectively using different currencies, depending upon their CTRs. The adjustment component 504 can accommodate varying click through rates or action rates for advertisers.

Calculation of fees or bids may be more complex when the market is defined as clicks or actual user selections of an advertisement, rather than impressions. Market value is based upon the total number of clicks, which can be difficult to predict. Previous market information can be used to compute an average CTR in addition to estimating market value. Looking again at the example described above, where advertiser A has requested a 30% market share and advertiser B has requested a 50% market share, the remaining 20% of the market can have an average CTR of 1 unit and an average bid of $1. Therefore, the market price would be equal to $1 per unit. Assuming that there were 1,000 occurrences or clicks within the 20% of the market analyzed, the total market should be 5,000 clicks or units at $1. Accordingly, to achieve 50% of the total market of 5,000, advertiser B would have to bid or pay $2500, adjusted by his particular CTR. For example, If advertiser B's CTR indicates that users are less likely to click on their advertisement than the average advertisement, then advertiser B's fee may be increased. An advertiser adjustment component 504 can adjust fees to accommodate differences between advertisers, including, but not limited to differences in discounts, special rates, monetization factors (e.g., click through rate and action rate), and the like.

The fee component 304 can also include a constraint component 506. The constraint component 506 can analyze any constraints associated with the market share request. The constraint component 506 can then determine whether fees would exceed or violate any constraints. For example, the constraint component 506 can compute the total cost to achieve market share up to current time and determine if any additional fees would exceed a maximum value defined in a constraint. The constraint component 506 can prevent further presentations of the advertisement to ensure that the constraint is not exceeded.

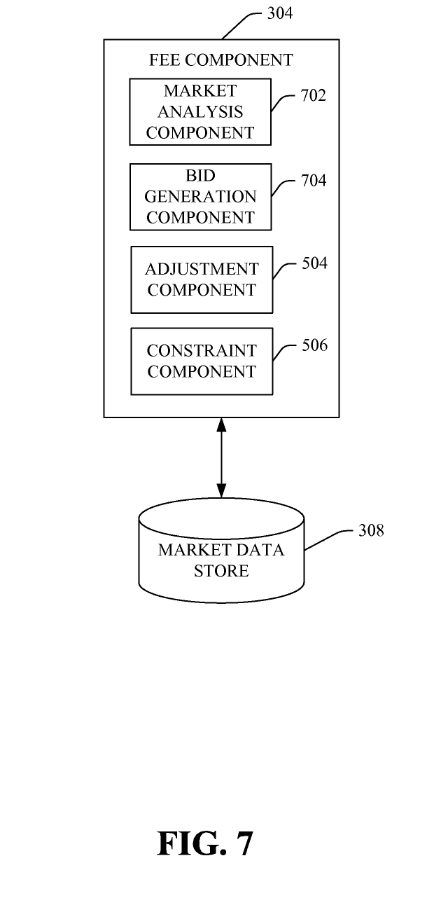

Turning now to FIG. 7, another aspect of a fee component 304 is illustrated. The fee component 304 can generate a bid strategy or bid price that can be used with an auction system to elect a share of a particular market. Fee component 304 can include a market evaluation component 702 that evaluates previous market information or data obtained from the market data store 308. A bid generation component can estimate a bid price likely to secure the desired market share based upon analysis of previous market distributions.

The market analysis component 702 can determine mean and or average bid price of presented advertisements in the market over a specified time frame. This mean bid price is relatively simple to compute and can be used to secure a particular percentage of the market. In general, the mean price is likely to win the bid approximately 50% of the time, if the market remains relatively stable. Consequently, an advertiser desiring a 50% share of the market can elect to bid the mean price for each advertising opportunity. An advertiser that desires 20% of the market can use a strategy of bidding the mean bid price for 40% of advertising opportunities, since the mean price is likely to be successful for half of the 40% of advertising opportunities, or 20% of the market. Other distribution information can be used to select appropriate bid prices.

Bid generation component 704 determines the appropriate bid or bid strategy for advertising opportunities based at least in part upon the mean bid price or distribution analyzed by the market analysis component. Returning to the example above where the advertiser desires 20% of the market and utilizes the mean bid price for 40% of advertising opportunities, the bid generation component 704 can simply use a bid price of zero the remaining 60% of the time. Alternatively, the bid generation component 704 can utilize a bid price less than or equal to the mean bid price. In this manner, the advertiser may be able to minimize costs and capture any movement in the market.

In other aspects, the bid generation component 704 can elect to bid a distribution based upon the mean bid price, rather than the mean bid price. Market can be affected by numerous variable, and are likely to fluctuate. Utilizing a distribution, such as a Gaussian distribution, may have a smoothing effect.

Periodically, the market data store 308 can be updated with new market distribution information. The market evaluation component 702 can compute an updated mean bid price. The bid generation component 704 can determine an updated bid price based upon the new information.

The fee component 304 can also include a constraint component 506 and an adjustment component 504, similar to the components illustrated in FIG. 5. Here, the constraint component 506 evaluates market share request constraints and prevents bids that would violate such constraints. Adjustment component 504 can adjust the estimated bid price based upon CTR, advertiser specific discounts and the like to facilitate obtaining the desired market share.

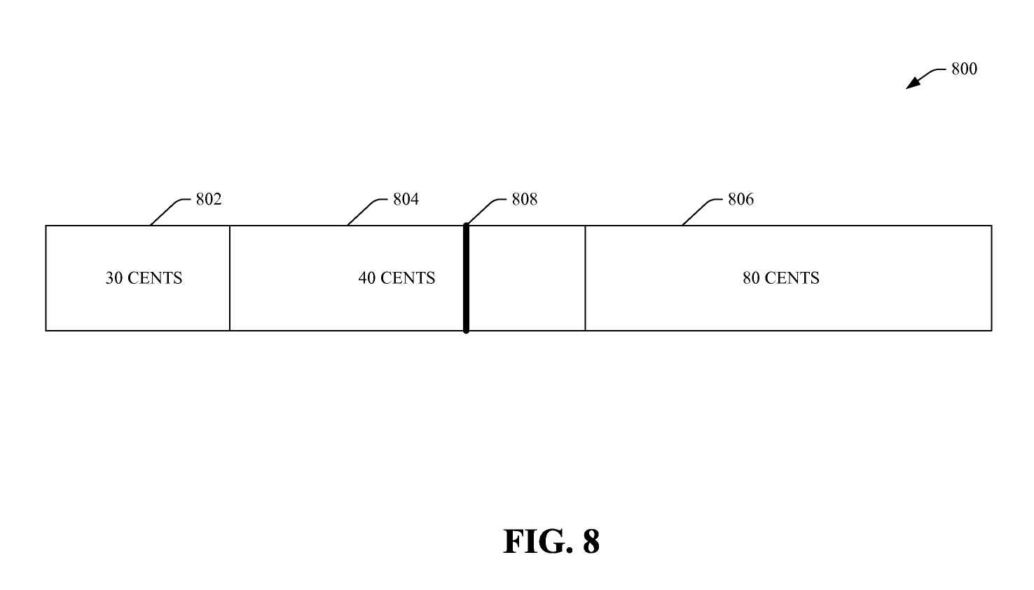

Turning now to FIG. 8, an exemplary distribution 800 of market prices is illustrated. The example is greatly simplified for brevity. Only three possible bid values are illustrated. A first portion 802 of the market had a price of 30 cents, a second portion 804 had a price of 40 cents and the final portion 806 had a price of 80 cents. Typically, an auction system could have numerous values. The bold line 808 indicates the midpoint of the distribution; one-half the successful bids are higher than this point, and one-half lower. In this example, an advertiser selecting a bid price of 41 cents would have a high probability of winning over half of the units on which the advertiser bid. Consequently, if an advertiser wanted a 20% share, the advertiser can bid 41 cents for approximately 40% of advertising opportunities. During the remaining page advertising opportunities, the advertiser can bid zero, or some amount lower than 41 cents. Alternatively, the advertiser could compute the bids based upon a Gaussian distribution centered at 41 cents.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

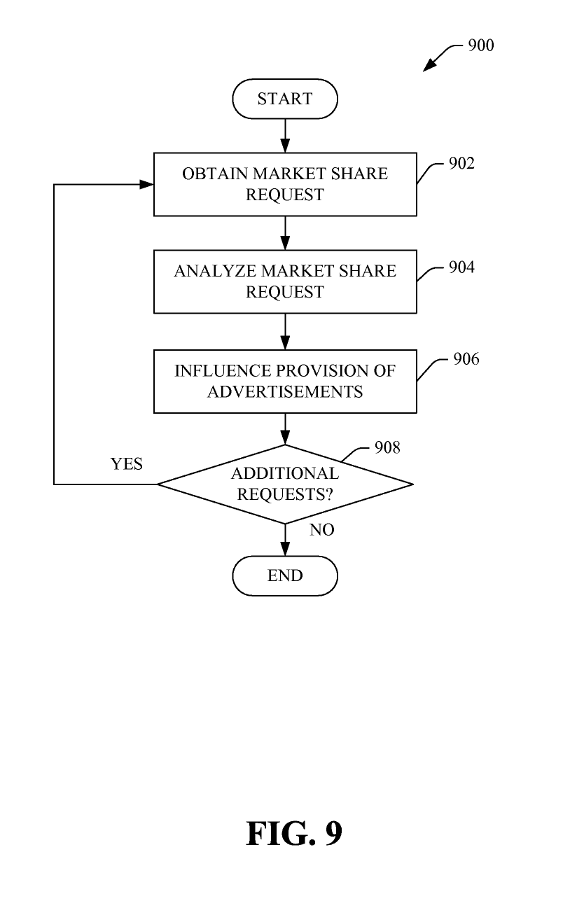

Turning now to FIG. 9, an exemplary methodology 900 for defining market share and facilitating market percentage based online advertising is illustrated. At 902, a market share request is obtained or received. The request can be received via a graphical user interface, an electronic file (e.g., word-processing document or text file), email, an audio message or any other suitable manner. The market share request can include a percentage request indicating the share of the market desired by a particular advertiser. The market share request can also include one or more attributes defining the market. For example, the desired market may include potential customers that perform searches utilizing a specific keyword or search term. The specified keyword can be considered an attribute of the market. Alternatively, a set of markets can be predefined and the market share request can reference one or more markets within the set.

The market share request can also include any constraints or limitations upon the request. These can include monetary as well as time constraints. For example, a flower retailer may be interested in securing a market share of 80% for the keywords “bouquet” and “roses” for the two weeks prior to Valentine's Day. Outside of that two-week period, the request is inapplicable. Monetary limitations can include a maximum total cost the advertiser is willing to spend to achieve the desired market share, as well as maximum costs per specified time frames. For example, an advertiser can define a maximum cost per a billing period.

At 904, the received market share request can be analyzed. In particular, the request can be evaluated for consistency. Additionally, if the request is an update or modification of a pre-existing request, the previous request can be identified and replaced or modified by the current market share request. The received request can be added to a set of maintained market share requests. The set can include any number of requests. For example, the set can include just a single received request, multiple requests from a single advertiser or requests from multiple advertisers. Multiple requests can be defined for a single market and/or requests can specify any number of markets. For example, multiple advertisers may be interested in a share of clicks resulting from searches utilizing the keyword “flowers.” Alternatively, one advertiser may target males under the age of thirty-five, while a second advertiser may be interested in females over the age of fifty.

At 906, presentation or provision of advertisements is influenced or affected by market share request. Provision of advertisements can be directly affected by controlling selection of advertisements or indirectly by controlling bids submitted in an auction system. At 908, a determination can be made as to whether there are additional market share requests. If yes, the process returns to 902 where the next market share request is obtained. If there are no additional requests, the process terminates.

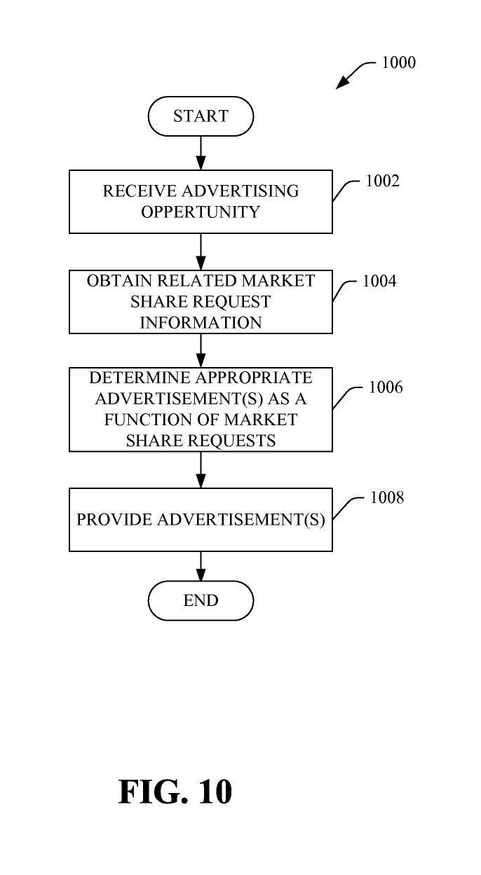

Turning now to FIG. 10, an exemplary methodology 1000 for online advertising based upon market share percentage is illustrated. At 1002, an advertising opportunity for presenting an advertisement occurs. For example, a page view request can be received or a particular web page or set of search results can be requested. Market share requests related to the market associated with the requested web page can be obtained at 1004. Based upon characteristics of the requested page, one or more relevant market share requests can be identified. For example, if the page view contains a list of search results for a specified keyword, relevant market share requests would include requests for a percentage of responses to that keyword. Any attributes associated with advertising opportunity, including information related to the potential customer, can be utilized to identify relevant market share requests. For example, relevant market share requests can be identified based upon user demographics (e.g., gender, age, geographic location, employment information and the like).

At 1006, the appropriate advertisement or advertisements can be determined based upon the relevant market share requests. In addition, order of presentation and position or location on the web page can also be determined based upon market share requests. A variety of methods can be used to select an advertisement or advertisements. In aspects, a biased random determination can be made for each advertising opportunity, such that the distribution over the set of advertising opportunities fulfills the market share requests. The determination can be effected by the particular attributes of the market share request, such as clicks, impressions and the like. In addition, any constraints included within the market share request can impact the determination.

The selected advertisement or advertisements can be provisioned at 1008. For instance, one or more advertisements can be displayed on a web page, or played on a media player. The process 1000 can be repeated for additional advertising opportunities.

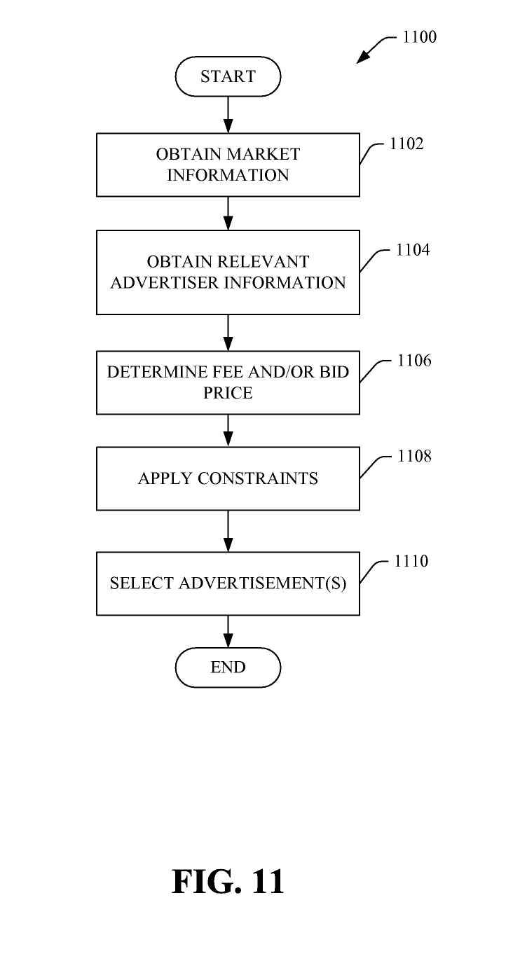

Referring now to FIG. 11, an exemplary methodology 1100 for determining appropriate advertisement(s) for an advertising opportunity is illustrated. At 1102, market information associated with a market can be obtained. For example, a history of previous impressions or clicks for a particular market can be retrieved from a data store. Market information can include various statistics such as bid prices, number of occurrences or events (e.g., impressions, clicks or actions) over various time periods, click through rates, potential customer demographics and the like.

At 1104, information specific to the advertiser requesting a market share can be obtained. Advertiser information can include information regarding total advertising costs for the particular advertiser, total advertising costs within the relevant market, advertising costs for specific time periods, number of occurrences of the advertiser's ad over a particular time period, current market share and the like. In addition, the click through rate for the advertiser can be obtained or determined.

The fee or bid price associated with the current advertising opportunity for each advertiser requesting a market share can be computed at 1106. Fees or bid prices can be computed as a function of market information (e.g., number of occurrences, average price, and CTR), advertiser information (e.g., individual CTRs, and discounts) as well as the relevant market request. At 1108, any constraints associated with the relevant market share requests are applied. For example, if an advertising opportunity would cause an advertiser to exceed a total maximum cost constraint, the advertiser's ad would not be presented. The advertisement or advertisements are selected for display at 1110. Selection can occur using an auction system and the computed bid prices for the various advertisements. The bid prices for advertisements, excluding any advertisements eliminated based upon constraints, can be provided to an auction system.

Alternatively, in aspects, an advertisement can be chosen using biased random selection consistent with requested market shares. For example, a random number generator can generate a number compared to a set of thresholds or ranges designed to reflect the requested market shares. Based upon the comparison the appropriate advertisement can be selected for display.

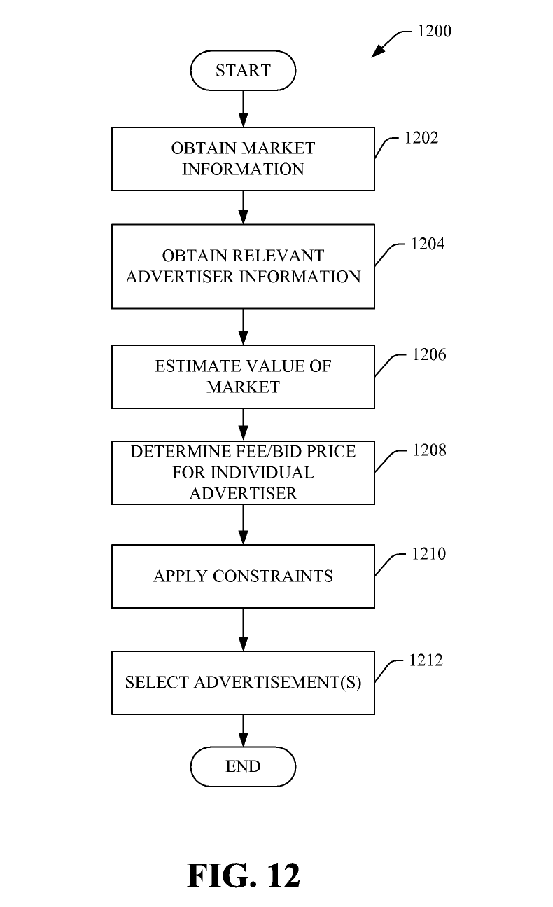

Turning now to FIG. 12, another exemplary methodology 1200 for determining appropriate advertisements for a page view is illustrated. At 1202, market information associated with a market can be obtained. For example, a history of previous impressions or clicks for a particular market can be retrieved from a data store. Market information can include various statistics such as bid prices, number of occurrences or events (e.g., impressions, clicks or actions) over various time periods, click through rates, potential customer demographics and the like.

At 1204, information specific to the advertiser requesting a market share can be obtained. Advertiser information can include information regarding total advertising costs for the particular advertiser, total advertising costs within the relevant market, advertising costs for specific time periods, number of occurrences of the advertiser's ad over a particular time period, current market share and the like. In addition, the click through rate for the advertiser can be obtained or determined.

At 1206, the total expected value of the market can be estimated. Such estimation can be based upon previous market information such as number of occurrences within a specified time period, average bid prices, average click through rates and the like. If only a portion of the market is used in computations (e.g., the portion of the market not allocated based upon market share requests), the value can be adjusted to predict the total market value. For example, if 20% of the market is equal to an estimated $1,000, the total estimated value of the market is equal to $5,000.

At 1208, fee or bid price for one or more individual advertisers can be calculated based upon the requested market share. Such fees can be adjusted based upon advertisers' click through rates as compared to an average click through rate. In addition, if the advertiser receives a discount or rate advantage, the fee or bid price can be adjusted.

At 1210, any constraints associated with market share requests are applied. For example, if the computed bid price would cause an advertiser to exceed a total maximum cost constraint, the advertiser's bid is not submitted. The advertisement or advertisements are selected for display at 1212. An advertisement can be chosen using biased random selection consistent with requested market shares. For example, a random number generator can generate a number compared to a set of thresholds or ranges designed to reflect the requested market shares. Based upon the comparison the appropriate advertisement can be selected for display.

In the aspects described above, the market information is obtained evaluated and market value generated for every page view. However, such computations can be performed periodically and maintained for multiple page view determinations. In addition, it is important to note that as the market information is updated for use in such computations, the fees and/or bid prices automatically adjust to reflect changes in the market.

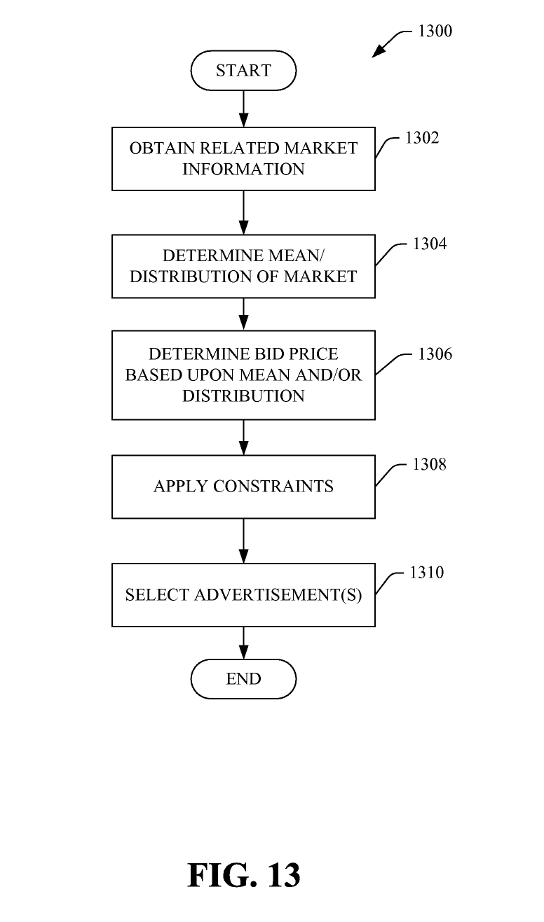

Turning now to FIG. 13, a further exemplary methodology 1300 for determining appropriate advertisements for a page view is illustrated. At 1302, market information associated with a market can be obtained. For example, a history of previous impressions or clicks for a particular market can be retrieved from a data store. Market information can include various statistics such as bid prices, number of occurrences or events (e.g., impressions, clicks or actions) over various time periods, click through rates, potential customer demographics and the like.

At 1304, the market information can be analyzed and a distribution of the market or a mean value of the market can be determined. At 1306, a bid price can be computed based upon the desired market share and the computed mean or distribution. For example, an advertiser utilizing the mean bid price may have a 50% chance of succeeding for a particular instance. If the advertiser desires 20% of the market share, the advertiser can utilize the mean bid price 40% of the time to achieve a 20% share. During the remaining 60% of the page view instances, the advertiser can utilize a bid price of zero. The advertiser can elect to utilize a bid price less than the mean bid price during the remaining 60% to minimize costs and capture movement of the market. Alternatively, the advertiser can use a distribution (e.g., a Gaussian distribution) around the mean bid price.

At 1308, any constraints associated with market share requests are applied. For example, if an advertiser bid price would exceed a total maximum cost constraint, the advertiser's bid price would not be submitted to an auction system. The advertisement or advertisements are selected for display at 1310. For example, an auction system can be utilized and advertisements can be selected based upon bid price.

In the aspects described above, the market information is obtained, evaluated and a distribution or mean generated for every page view. However, such computations can be performed periodically and maintained for multiple page view determinations. In addition, it is important to note that as the market information is updated and used in such computations, the fees and bid prices are adjusted to reflect the changes in the market.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

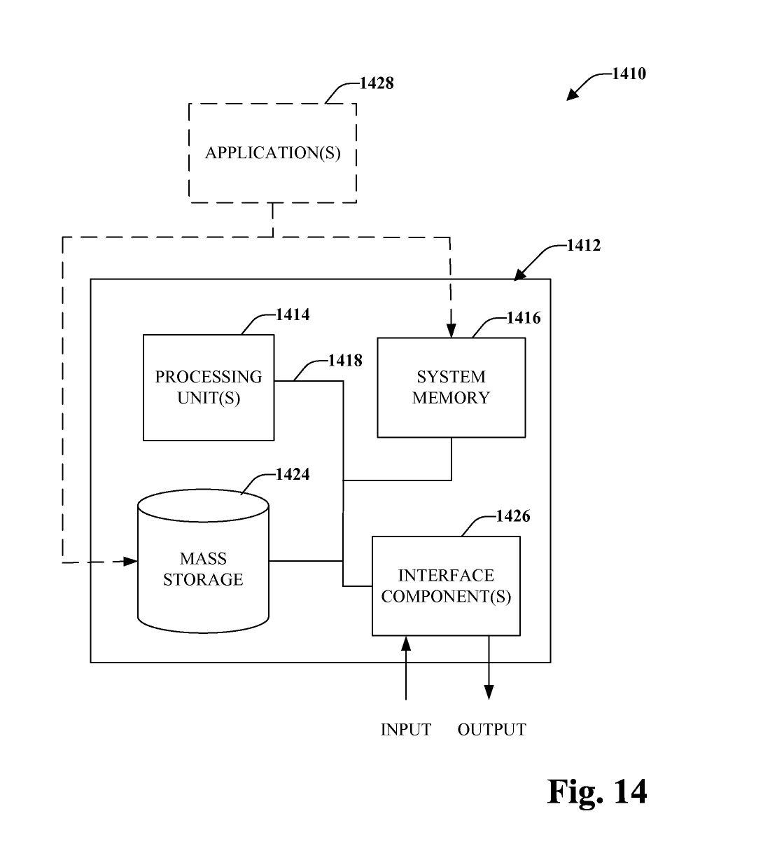

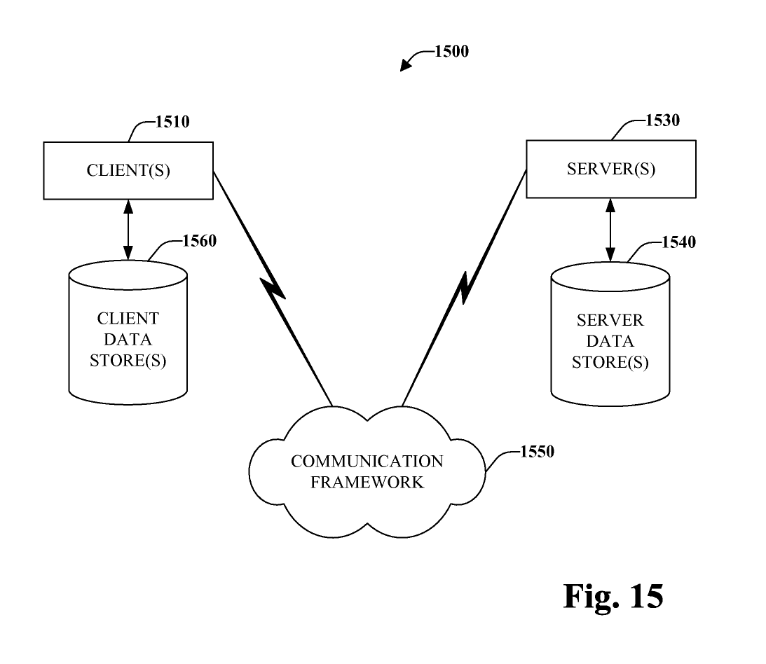

In order to provide a context for the various aspects of the disclosed subject matter, FIGS. 14 and 15 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 14, an exemplary environment 1410 for implementing various aspects disclosed herein includes a computer 1412 (e.g., desktop, laptop, server, hand held, programmable consumer or industrial electronics . . . ). The computer 1412 includes a processing unit 1414, a system memory 1416, and a system bus 1418. The system bus 1418 couples system components including, but not limited to, the system memory 1416 to the processing unit 1414. The processing unit 1414 can be any of various available microprocessors. It is to be appreciated that dual microprocessors, multi-core and other multiprocessor architectures can be employed as the processing unit 1414.

The system memory 1416 includes volatile and nonvolatile memory. The basic input/output system (BIOS), containing the basic routines to transfer information between elements within the computer 1412, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1412 also includes removable/non-removable, volatile/non-volatile computer storage media. FIG. 14 illustrates, for example, mass storage 1424. Mass storage 1424 includes, but is not limited to, devices like a magnetic or optical disk drive, floppy disk drive, flash memory or memory stick. In addition, mass storage 1424 can include storage media separately or in combination with other storage media.

FIG. 14 provides software application(s) 1428 that act as an intermediary between users and/or other computers and the basic computer resources described in suitable operating environment 1410. Such software application(s) 1428 include one or both of system and application software. System software can include an operating system, which can be stored on mass storage 1424, that acts to control and allocate resources of the computer system 1412. In particular, operating system can include diagnostic components capable of monitoring and averting failure of a hard disk drive. Application software takes advantage of the management of resources by system software through program modules and data stored on either or both of system memory 1416 and mass storage 1424.

The computer 1412 also includes one or more interface components 1426 that are communicatively coupled to the bus 1418 and facilitate interaction with the computer 1412. By way of example, the interface component 1426 can be a port (e.g., serial, parallel, PCMCIA, USB, FireWire . . . ) or an interface card (e.g., sound, video, network . . . ) or the like. The interface component 1426 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1412 to output device(s) via interface component 1426. Output devices can include displays (e.g., CRT, LCD, plasma . . . ), speakers, printers and other computers, among other things.

FIG. 15 is a schematic block diagram of a sample-computing environment 1500 with which the subject innovation can interact. The system 1500 includes one or more client(s) 1510. The client(s) 1510 can be hardware and/or software (e.g., threads, processes, computing devices). The system 1500 also includes one or more server(s) 1530. Thus, system 1500 can correspond to a two-tier client server model or a multi-tier model (e.g., client, middle tier server, data server), amongst other models. The server(s) 1530 can also be hardware and/or software (e.g., threads, processes, computing devices). The servers 1530 can house threads to perform transformations by employing the aspects of the subject innovation, for example. One possible communication between a client 1510 and a server 1530 may be in the form of a data packet transmitted between two or more computer processes.

The system 1500 includes a communication framework 1550 that can be employed to facilitate communications between the client(s) 1510 and the server(s) 1530. The client(s) 1510 are operatively connected to one or more client data store(s) 1560 that can be employed to store information local to the client(s) 1510. Similarly, the server(s) 1530 are operatively connected to one or more server data store(s) 1540 that can be employed to store information local to the servers 1530. Both the one or more client data store(s) 1560 and the one or more server data store(s) can utilize hard disk drives to maintain data. Both client(s) 1510 and server(s) 1530 can utilize a diagnostic component to prevent failure of data stores and mitigate loss of data.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system that facilitates online advertising, comprising:
a receive component that obtains a market share request from an advertiser; and
a request manager component that influences provisioning of an advertisement as a function of the request.

2. The system of claim 1, further comprising a fee component that computes cost to the advertiser as a function of market information and the market share request.

3. The system of claim 2, the fee component updates the bid price as a function of an update to the market information.

4. The system of claim 2, further comprising a market value component that estimates a value of a market referenced by the market share request as a function of the market information, the cost is computed based at least in part upon a requested percentage included in the market share request.

5. The system of claim 2, further comprising:
a market analysis component that analyzes distribution of bids in the market information; and
a bid generation component that determines a bid strategy designed to secure a requested percentage included in the market share request, the bid strategy is a function of the analysis of the distribution.

6. The system of claim 5, the market analysis component computes a mean bid price; the bid strategy is based at least in part upon the mean bid price.

7. The system of claim 2, further comprising an adjustment component that adjusts the cost based at least in part upon a monetization factor associated with the advertiser.

8. The system of claim 1, the market share request includes a set of attributes that define a market.

9. The system of claim 8, the set of attributes defines a demographic for a potential customer.

10. The system of claim 1, the market share request includes at least one constraint that defines a monetary limitation.

11. A methodology that facilitates percentage-based online advertising, comprising:
obtaining a market percentage request that specifies a percentage desired by an advertiser for a market; and
affecting presentation of an advertisement to a potential customer based at least in part upon the request.

12. The methodology of claim 11, further comprising selecting the advertisement in response to an advertising opportunity, selection utilizes using a biased random determination; wherein the bias is designed to effect the desired percentage.

13. The methodology of claim 11, further comprising:
evaluating past behavior of the market; and
computing an advertiser cost based at least in part upon the evaluation.

14. The methodology of claim 13, further comprising submitting a bid as a function of the advertiser cost.

15. The methodology of claim 13, further comprising applying a constraint to the advertiser cost, the constraint is specified in the market percentage request.

16. The methodology of claim 13, further comprising:
evaluating a monetization factor associated with the advertiser; and
adjusting the advertiser cost based at least in part upon the monetization factor.

17. The methodology of claim 13, further comprising:
analyzing distribution of bids from the past behavior of the market; and
designing a bid strategy to secure the desired percentage of the market utilizing the analysis.

18. The methodology of claim 13, further comprising:
computing a mean bid price based upon the past behavior of the market; and
submitting a bid for the advertisement opportunity based at least in part upon the mean bid price.

19. The methodology of claim 11, the market is defined based at least in part upon user demographics.

20. A system that facilitates percentage-based advertising system, comprising:
means for analyzing at least one market share request;
means for means for evaluating market information that describes previous behavior of the market associated with the market share request; and
means for influencing provision of an advertisement as a function of the at least one market share request and the evaluation of the market information.
